(19) United States
(12) Patent Application Publication
(10) Pub. No.: US 2023/0195524 A1
(43) Pub. Date: Jun. 22, 2023

(54) SYSTEM AND METHOD FOR A VIRTUAL OBJECT STORE

(71) Applicant: Nutanix, Inc., San Jose, CA (US)

(72) Inventors: Joe Patrick Maley, Bangalore (IN); Gowtham Alluri, Bangalore (IN); Dhruv Doshi, Bangalore (IN)

(73) Assignee: Nutanix, Inc., San Jose, CA (US)

(21) Appl. No.: 18/080,563

(22) Filed: Dec. 13, 2022

(30) Foreign Application Priority Data
Dec. 16, 2021 (IN) 202141058606

(51) Int. Cl. G06F 9/50; G06F 9/54

(52) U.S. Cl. CPC G06F 9/5033; G06F 9/547

(57) ABSTRACT

An illustrative embodiment disclosed herein is an apparatus comprising a processor and a memory. In some embodiments, the memory includes programmed instructions that, when executed by the processor, cause the apparatus to receive a first object request to execute an input/output (I/O) on an object stored in an on-premises object store, select a target cloud object store of a plurality of cloud object stores, translate the first object request to a second object request to execute the I/O on the object, and send the second object request to the target cloud object store. In some embodiments, the first object request is in accordance with a first protocol of the on-premises object store. In some embodiments, the plurality of object stores is coupled to the on-premises object store. In some embodiments, the second object request is in accordance with a second protocol of the target cloud object store.

### CROSS REFERENCE TO RELATED APPLICATIONS

This application claims priority to Indian Provisional Application No. 202141058606, filed Dec. 16, 2021, which application is incorporated herein by reference in its entirety.

### BACKGROUND

Cloud computing can include on-demand availability of computer system resources including data storage and computing power, without direct active management by the user. Large clouds can have functions distributed over multiple locations.

### SUMMARY

Aspects of the present disclosure relate generally to a computing environment, and more particularly to a system and method for implementing a virtual object store.

An illustrative embodiment disclosed herein is an apparatus comprising a processor and a memory. In some embodiments, the memory includes programmed instructions that, when executed by the processor, cause the apparatus to receive a first object request to execute an input/output (I/O) on an object stored in an on-premises object store, select a target cloud object store of a plurality of cloud object stores, translate the first object request to a second object request to execute the I/O on the object, and send the second object request to the target cloud object store. In some embodiments, the first object request is in accordance with a first protocol of the on-premises object store. In some embodiments, the plurality of object stores is coupled to the on-premises object store. In some embodiments, the second object request is in accordance with a second protocol of the target cloud object store.

Another illustrative embodiment disclosed herein is a non-transitory computer readable storage medium comprising instructions stored thereon that, when executed by a processor, cause the processor to receive a first object request to execute an input/output (I/O) on an object stored in an on-premises object store, select a target cloud object store of a plurality of cloud object stores, translate the first object request to a second object request to execute the I/O on the object, and send the second object request to the target cloud object store. In some embodiments, the first object request is in accordance with a first protocol of the on-premises object store. In some embodiments, the plurality of object stores is coupled to the on-premises object store. In some embodiments, the second object request is in accordance with a second protocol of the target cloud object store.

Another illustrative embodiment disclosed herein is a method including receiving a first object request to execute an input/output (I/O) on an object stored in an on-premises object store, selecting a target cloud object store of a plurality of cloud object stores, translating the first object request to a second object request to execute the I/O on the object, and sending the second object request to the target cloud object store. In some embodiments, the first object request is in accordance with a first protocol of the on-premises object store. In some embodiments, the plurality of object stores is coupled to the on-premises object store. In some embodiments, the second object request is in accordance with a second protocol of the target cloud object store.

Further details of aspects, objects, and advantages of the disclosure are described below in the detailed description, drawings, and claims. Both the foregoing general description and the following detailed description are exemplary and explanatory, and are not intended to be limiting as to the scope of the disclosure. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates a system for implementing a virtual object store, in accordance with some embodiments;

FIGS. 2A-2B illustrate an exemplary mappings, in accordance with some embodiments;

FIG. 3 illustrates a system for replicating an object from the virtual object store to a remote object store, in accordance with some embodiments;

FIG. 4 illustrates a system for replicating an object from a remote object store to the virtual object store, in accordance with some embodiments;

FIG. 5 illustrates a flowchart of an example method for sending an object I/O to a remote object store, in accordance with some embodiments of the present disclosure;

FIG. 6 illustrates a flowchart of an example method for receiving an object I/O from a remote object store, in accordance with some embodiments of the present disclosure;

FIG. 7A is a block diagram depicting an implementation of a network environment including a client device in communication with a server device;

FIG. 7B is a block diagram depicting a cloud computing environment including a client device in communication with cloud service providers; and

FIG. 7C is a block diagram depicting an implementation of a computing device that can be used in connection with the systems depicted in FIGS. 1, 3, 4, 7A, and 7B, and the method depicted in FIGS. 5 and 6.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

In some embodiments, different cloud providers of object storage have differences in their application programming interfaces (APIs). For example, the names of the respective APIs are different, the respective APIs provide different optional features such as filtering, the respective APIs interpret input parameters differently, or the output parameters returned by the respective APIs are different. In some embodiments lacking the improvements disclosed herein, to support replication between an enterprise object store (e.g., an on-premises object store) and object stores on the public cloud, a user of the enterprise object store may need to manually perform I/O with an API unique to each object store. Thus, what is needed is a way to simplify I/O implementation among different endpoints.

Disclosed herein are embodiments of a system and method of a virtual object store. The virtual object store can expose object-level I/O and event handling among heterogeneous object store services such as object stores from different cloud providers. In some embodiments, the virtual object store receives a first object request in a first protocol, translates the first object request to a second object request in a second protocol and sends the second object request to a target object store. The virtual store can translate a first identifier in the first object request to a second identifier in the second object request. The first identifier can be in the first protocol and the second identifier can be in the second protocol. The target object store can be another instance of the enterprise object store or a public cloud object store. Advantageously, the protocols of the heterogeneous object stores remain hidden to the user of the virtual object store. The virtual object store can be used for any type of object movement between the enterprise object store and another object store, including object replication, remote bucket caching, and object migration.

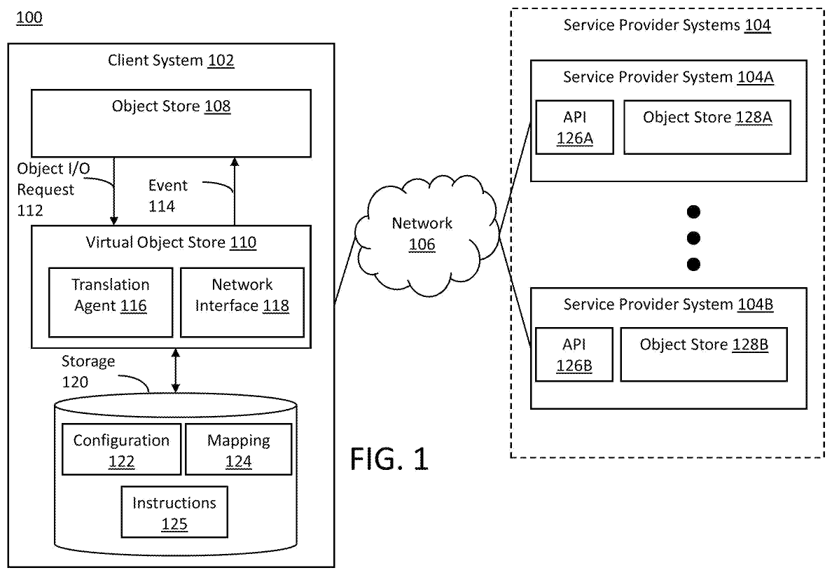

FIG. 1 illustrates a system 100 for implementing a virtual object store, in accordance with some embodiments. The system 100 includes a client system 102, a number of service provider systems 104, and a network 106 coupling the client system 102 to the service provider systems 104.

In some embodiments, the client system 102 includes an object store 108. The object store 108 can be referred to as an object storage platform. The object store 108 can store objects (e.g., object data). An object can be composed of the object itself and metadata about the object. An object can include unstructured data. An object can include immutable data. The object store 108 can include buckets that are logical constructs where the objects are stored. Each bucket can be associated with a single set of resources. Each bucket can be associated with a single set of policies. The buckets can be backed by one or more virtual disks or portions (e.g., regions) thereof. The object store 108 can have a flat hierarchy (e.g., no directory, sub-folders, or sub-buckets). The object store 108 can have a single namespace or a unique namespace for each of multiple tenants (e.g., users). Objects can be managed using a representational state transfer (REST) API built on hypertext transfer protocol (HTTP) verbs (e.g., standard HTTP verbs such as GET, PUT, and DELETE). Users can define object names when they upload an object. The object store 108 can prepend an object store namespace string and a bucket name to the object name. A directory structure can be simulated by adding a prefix string that includes a forward slash.

The object store 108 can send object input/output (I/O) 112. For example, the object store 108 can send a request to read (GET) or write an object (PUT). The object store 108 can receive event 114. For example, the object store 108 can receive a notification that an object has been written (e.g., uploaded to a bucket), updated, or deleted. The object store 108 can include a user interface that is operated by a user or administrator.

The client system 102 includes a virtual object store 110. The virtual object store 110 can be an abstraction layer to expose object-level I/O and event handling among heterogeneous object store services (e.g., object store services of the service provider systems 104). The virtual object store 110 can enable the object store 108 to send object I/O request 112 and receive event 114 in a unified protocol regardless of the endpoint that is communicating with the client system 102. The virtual object store 110 can receive the object I/O request 112 from the object store 108 and send the event 114 to the object store 108.

In some embodiments, the virtual object store 110 includes a translation agent 116. The translation agent 116 can receive the object I/O request 112 that is in accordance with a first protocol (e.g., format, syntax, naming convention etc.) and translate the object I/O request 112 to a second object I/O that is in accordance with a second protocol (e.g., a different format, syntax, naming convention etc.). In some embodiments, the client system 102 includes a storage 120 coupled to the virtual object store 110. In some embodiments, the storage 120 includes a database. In some embodiments, the storage 120 includes non-transient storage or memory. In some embodiments, the translation agent 116 accesses a configuration 122 stored in the storage 120. The translation agent 116 identifies an endpoint (e.g., endpoint type, endpoint identifier) for sending object I/O (or receiving events) in the configuration 122. In some embodiments, the configuration 122 is configured/set up (e.g., an endpoint identifier is added to the configuration) based on a policy such as a load balancing policy. In some embodiments, an administrator configures the configuration 122 before or at the time that the virtual object store 110 is deployed or configured. In some embodiments, a user configures the configuration 122.

In some embodiments, the translation agent 116 accesses a mapping 124 in the storage 120. In some embodiments, the translation agent 116 uses the mapping 124 to translate one or more first identifiers of the object I/O request 112 or the event 114, which is in the unified protocol, to one or more second identifiers of an object I/O request or event corresponding to the endpoint, which is in its own protocol. In some embodiments, the translation agent 116 translates one or more second identifiers from a protocol of one of the endpoints to the unified protocol.

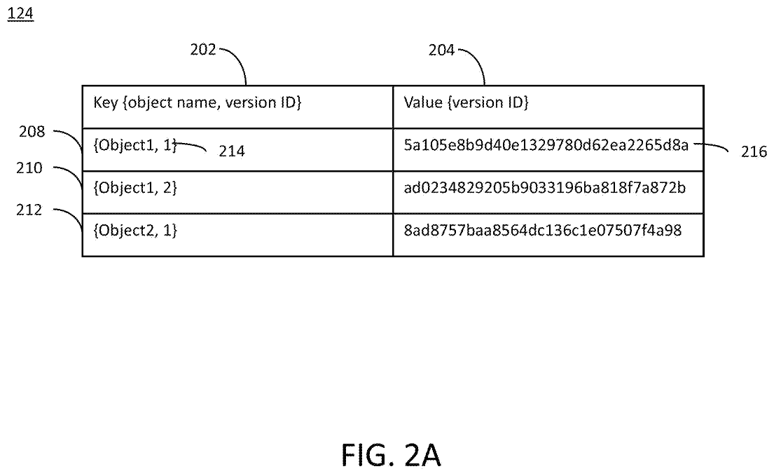

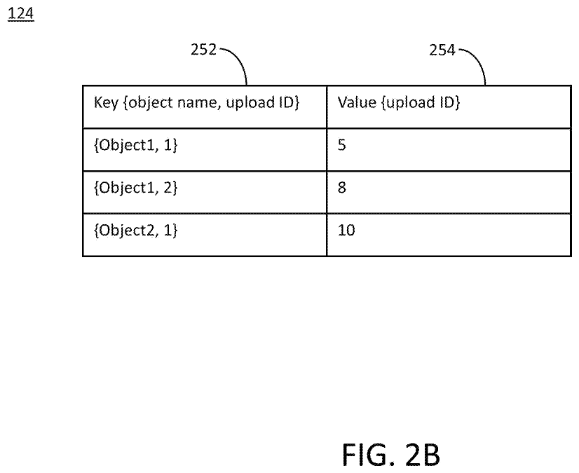

FIG. 2A illustrates an exemplary mapping 124, in accordance with some embodiments of the present disclosure. In some embodiments, the mapping 124 is arranged as a table with a number of columns and rows. In some embodiments, the mapping 124 includes a column 202 that includes a list of entries, wherein each entry includes an object name and version ID in one of protocols (e.g., the protocol of a source object store from which the object request I/O or event is being sent). In some embodiments, the mapping 124 includes a list of entries, wherein each entry includes a version ID in a different one of the protocols (e.g., the protocol of a destination object store to which the object request I/O or event is being sent). Each object name-version ID pair may be referred to as a key. Each version ID in column 204 may be referred to as a value. In some embodiments, the mapping 124 includes a row 208 that includes (e.g., is identified by) a first object name-version ID pair, a row 210 that includes a second object name-version ID pair, and a third row 212 that includes a third object name-version ID pair. Although the mapping 124 shows three rows, the mapping 124 can include greater than or less than three rows. Although only one mapping is shown, the mapping 124 can include greater than one mapping. Each mapping can be a separate data structure or a separate part (e.g., a separate page) of the same data structure. Although the mapping 124 is described as a table with rows and columns, the mapping 124 can be implemented as any data structure such as any kind of relational database or a non-relational database. In some embodiments, the mapping 124 can be encoded as instructions.

In some embodiments, the translation agent 116 identifies a row using a key in the object I/O request 112 and retrieves a value from the identified row. For example, the translation agent 116 identifies the row 208, which has a key 214 (in an entry where the row 208 intersects the column 202) that matches the key in the object I/O request 112. After identifying the row 208, the translation agent 116 can retrieve the value 216 from the row 208 (in an entry where the row 208 intersects the column 204). Although the translation agent 116 matches the key 214 to an the object I/O request 112, matching the key 214 to an event 114 is within the scope of the disclosure.

FIG. 2B illustrates another exemplary mapping 124, in accordance with some embodiments of the present disclosure. In some embodiments, the mapping 124 of FIG. 2B is similar to the mapping 124 of FIG. 2A except for the following. In some embodiments, the mapping 124 includes a column 252 that includes a list of entries, wherein each entry includes an object name and upload ID in one of protocols (e.g., the protocol of a source object store from which the object request I/O or event is being sent). In some embodiments, the mapping 124 includes a column 254 that includes a list of entries, wherein each entry includes an upload ID in a different one of the protocols.

Returning to FIG. 1, in some embodiments, the translation agent 116 uses the endpoint identifier in the configuration 122 and the instructions 125 to translate an API of the object I/O request 112 or the event 114, which is in the unified protocol, to an API of the object I/O or event corresponding to the endpoint, which is in its own protocol. For example, if the endpoint parameter in the configuration 122 indicates a first endpoint, the translation agent 116 executes the instructions 125 to translate a first API “VOS:ObjectPut( )” to a second API “OS1:ObjectPut( )”, and if the endpoint parameter in the configuration 122 indicates a second endpoint, the translation agent 116 executes the instructions 125 to translate the first API “VOS:ObjectPut( )” to a third API “OS2:ObjectPut( )” The translation agent 116 can use the instructions to translate from an API of a remote storage protocol to an API of the unified protocol.

In some embodiments, the translation agent 116 uses the endpoint identifier in the configuration 122 and the instructions 125 to select one of the mappings of the mapping 124. For example, if the endpoint parameter in the configuration 122 indicates a first endpoint, the translation agent 116 executes the instructions 125 to access a first mapping that translates a first identifier of the endpoint (e.g., the associated version, upload, etc.) to a second identifier of the endpoint, and if the endpoint parameter in the configuration 122 indicates a second endpoint, the translation agent 116 executes the instructions 125 to access a second mapping that translates the first identifier of the endpoint to a third identifier of the endpoint.

In some embodiments, the virtual object store 110 includes a network interface 118. In some embodiments, the network interface 118 sends the translated object request to an endpoint of the service provider systems 104. In some embodiments, the network interface 118 receives an event from the service provider systems 104 and the translation agent 116 translates the event into the event 114.

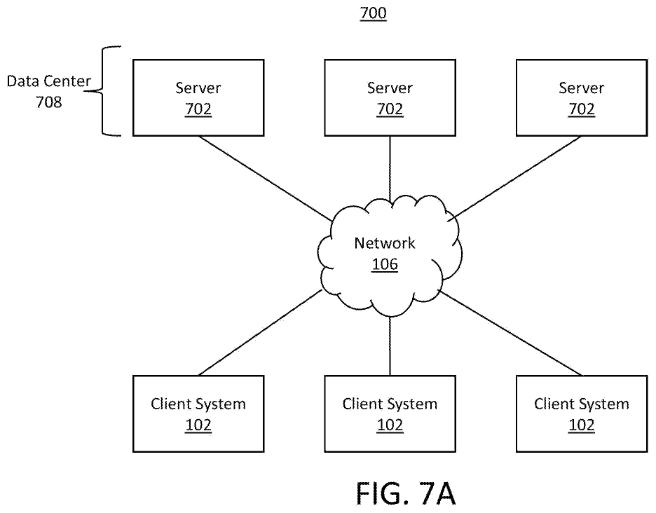

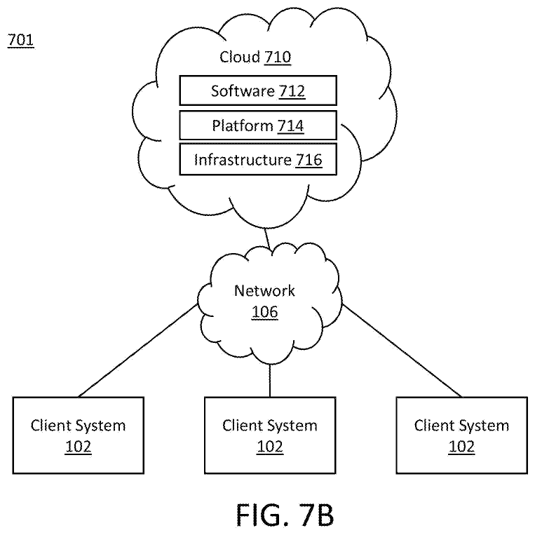

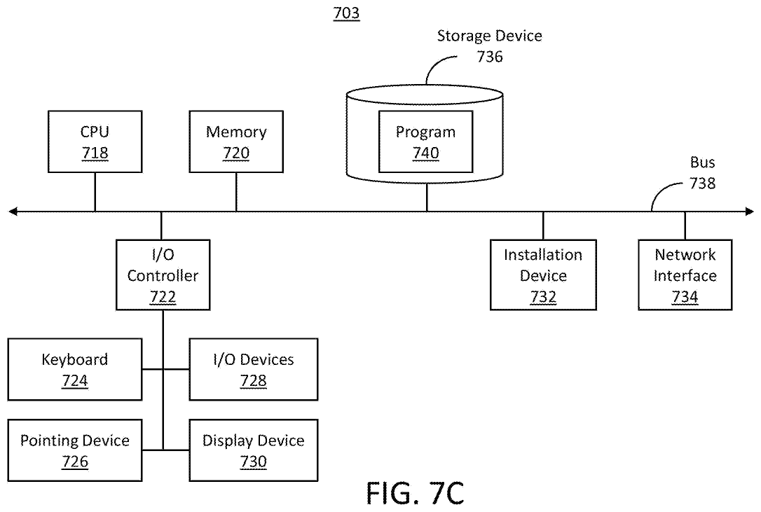

In some embodiments, each of the service provider systems 104 can be hosted by a third-party cloud service provider. Each of the service provider systems 104 can be hosted in a cloud such as a public cloud, a private cloud, a hybrid cloud, a multicloud, or a co-location facility. Each of the service provider systems 104 can be hosted in a private data center, or on one or more physical servers, virtual machines, or containers of an entity or customer. The service provider systems 104 can be remote from the client system 102. For example, the client system 102 accesses the service provider systems 104 through a public network (e.g., the network 106). Each of the service provider systems 104 can be hosted on or refer to cloud 710 depicted in FIG. 7B.

In some embodiments, the service provider systems 104 include a service provider system 104A and a service provider system 104B. Although two service provider systems 104A and 104B are shown, the service provider systems 104 can include a greater number of service provider systems and remain within the scope of the present disclosure. Each service provider system can include an API. For example, the service provider system 104A includes an API 126A and the service provider system 104B includes an API 126B. In some embodiments, each API is unique to the respective object store. Each API can receive a translated object request that is in accordance with a protocol associated with the API and the corresponding object store. In some embodiments, one or more of the APIs are REST APIs over HTTP or http secure (HTTPS).

Each service provider system can include an object store. For example, the service provider system 104A includes an object store 128A and the service provider system 104B includes an object store 128B. In response to receiving the translated object request, an API can make a call to the corresponding object store. For example, if the API 126A receives a translated object request, the API 126A makes an API call to the object store 128A to perform an operation in accordance with the translated object request. The object store can send a response to the API with the requested information and the API can transfer the response to the client system 102.

The network 106 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 106 may include a wireless link, such as an infrared channel or satellite band. The topology of the network 106 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”), universal mobile telecommunications system (“UMTS”), long-term evolution (“LTE”), or 5G new radio (“NR”). Different types of data may be transmitted via different protocols, or the same types of data may be transmitted via different protocols.

Each of the client system 102 or the service provider system 104 can include or utilize at least one processing unit or other logic device such as programmable logic array engine, or module configured to communicate with one another or other resources or databases. The system 100 and its components can include hardware elements, such as one or more processors, logic devices, or circuits.

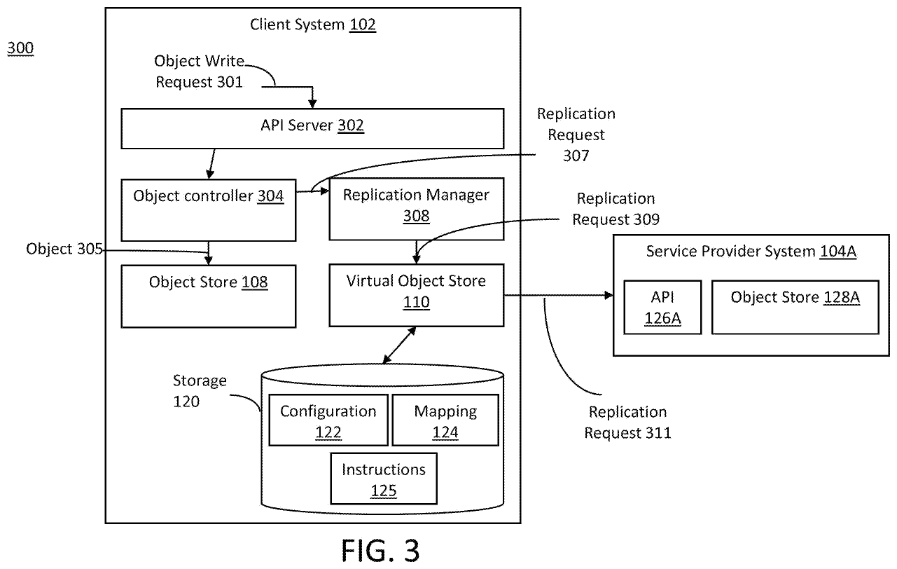

FIG. 3 illustrates a system 300 for replicating an object from the virtual object store 110 to a remote object store (e.g., the object store 128A), in accordance with some embodiments. In some embodiments, the system 300 includes the client system 102 and the service provider system 104A. In some embodiments, the client system 102 includes an API server 302. The API server 302 can receive an object write request 301. The API server 302 can send the object write request 301 to an object controller 304.

In some embodiments, the client system 102 includes the object controller 304. In some embodiments, the object controller 304 executes the object write of the object write request 301. In some embodiments, the object controller 304 stores the object 305 (e.g., object data and metadata) in the object store 108. In some embodiments, the object controller 304 sends a replication request 307 to a replication manager 308. The replication request 307 may be a request to create a replication request 309 (e.g., an API request, an API call, etc.)

In some embodiments, the client system 102 includes a replication manager 308. In some embodiments, the replication manager 308 creates the replication request 309. In some embodiments, the replication manager 308 calls the virtual object store 110, which uses the storage 120 to translate the replication request 309 into a replication request 311 having a protocol used by the service provider system 104A. For example, the virtual object store 110 translates an API or at least one identifier in the API. Details of the virtual object store 110 and the storage 120 described with respect to FIG. 1 are within the scope of the embodiments of FIG. 3.

In some embodiments, the system 300 is an embodiment of the system 100 of FIG. 1. In some embodiments, the system 100 or the system 300 can be used for any type of object movement or other operation (e.g., remote bucket caching or object migration).

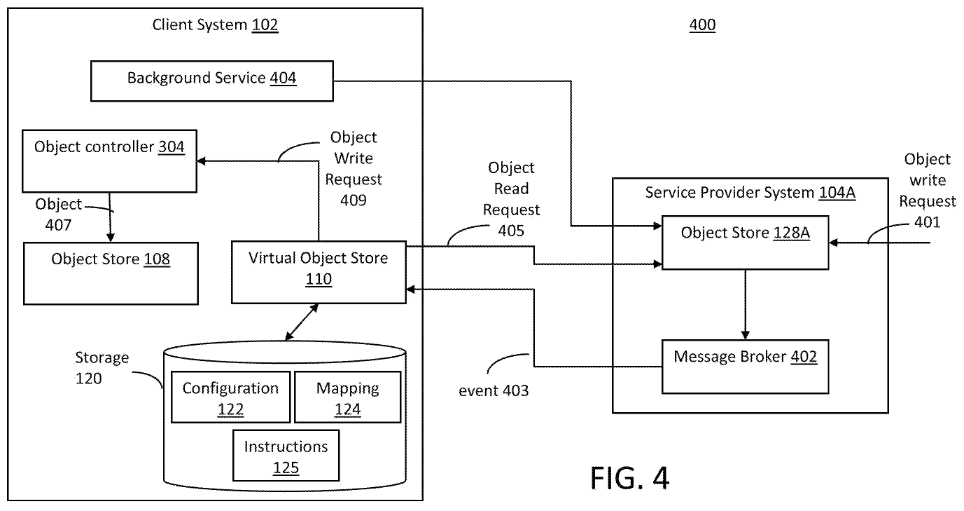

FIG. 4 illustrates a system 400 for replicating an object from a remote object store (e.g., the object store 128A) to the virtual object store 110, in accordance with some embodiments. In some embodiments, the system 400 includes the client system 102 and the service provider system 104A. In some embodiments, the service provider system 104A includes a message broker 402 (e.g., a publish/subscribe message service). The virtual object store 110 of the client system 102 can be configured to receive events from the message broker 402. For example, the virtual object store 110 can subscribe to the message broker 402. The message broker 402 can receive an event 403 from the object store 128A of the service provider system 104A. The event 403 can be based on the object store 128A executing an object write of an object write request 401. Responsive to the message broker 402 receiving the event 403, the message broker 402 sends (e.g., pushes, transfers) the event 403 to the subscribed object stores, including the virtual object store 110.

In some embodiments, the virtual object store 110 uses the storage 120 to translate the event 403 received from the message broker 402 from a protocol of the service provider system 104A to the unified protocol. For example, the virtual object store 110 uses the storage 120 to translate a first one or more identifiers of the event 403 to a second one or more identifiers. Details of the virtual object store 110 and the storage 120 described with respect to FIG. 1 are within the scope of FIG. 4.

In some embodiments, the virtual object store 110 sends an object read request 405 (e.g., invokes a callback) to the object store 128A. In some embodiments, the virtual object store 110 receives (e.g., retrieves, fetches, downloads) or accesses the object 407, or delta of the object 407, from the object store 128A. The delta (e.g., difference, change, etc.) can be between the object 407 before and after the object write of the object write request 401 was executed.

In some embodiments, the virtual object store 110 sends an object write request 409 to the object controller 304. In some embodiments, the virtual object store 110 translates the receipt of the object read request 405 to the object write request 409 (e.g., translates the API or at least one identifier). In some embodiments, the object controller 304 executes the object write of the object write request 409. In some embodiments, the object controller 304 stores the object 407 or the delta in the object store 108.

In some embodiments, the client system 102 includes a background service 404. The background service 404 can serve as a stopgap in case communication between the message broker 402 and the virtual object store 110 fails. In some embodiments, the background service 404 searches (e.g., scans, looks for) a delta of one or more objects in the object store 128A. In some embodiments, the background service 404 receives or accesses the delta. In some embodiments, the background service 404 stores the delta in the virtual object store 110 or the object store 108.

In some embodiments, the system 400 is an embodiment of the system 100 of FIG. 1. In some embodiments, the system 100 or the system 400 can be used for any type of object movement (e.g., remote bucket caching or object migration).

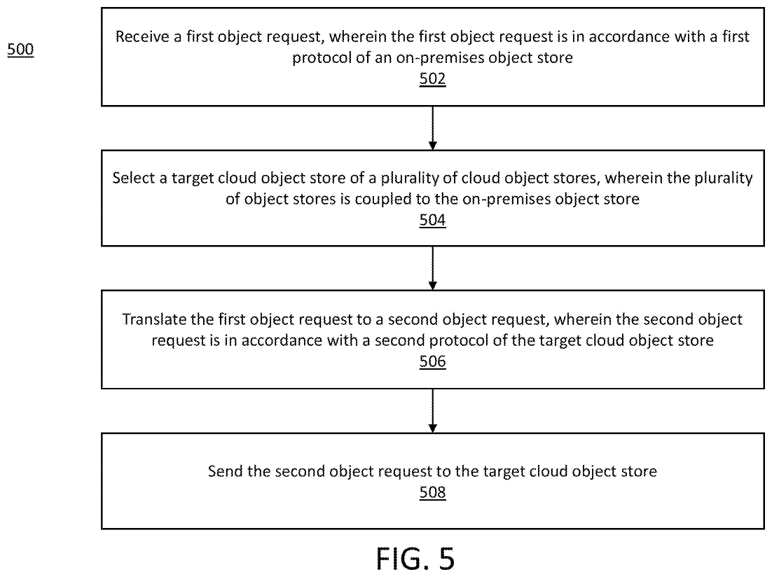

Referring now to FIG. 5, a flowchart of an example method 500 for sending an object I/O to a remote object store, in accordance with some embodiments of the present disclosure. The method 500 may be implemented using, or performed by one or more of the systems (e.g., the system 100, the system 300, the system 400, the network environment 700, the cloud computing environment 701, or the computing device 703), one or more components (e.g., the client system 102, virtual object store 110, the translation agent 116, the replication manager 308, etc.) of one or more of the systems, or a processor associated with one or more of the systems or one or more components. Additional, fewer, or different operations may be performed in the method 500 depending on the embodiment. Additionally, or alternatively, two or more of the operations of the method 500 may be performed in parallel.

At operation 502, the processor (e.g., a processor of the virtual object store 110) receives a first object request (e.g., the object I/O request 112). In some embodiments, the first object request is to execute an I/O on an object stored in an enterprise (e.g., on-premises) object store (e.g., the object store 108). In some embodiments, the first object request is in accordance with a first protocol of the enterprise object store.

At operation 504, the processor selects a target object store (e.g., the object store 128A) of a plurality of object stores (the object store 128A and 128B). In some embodiments, the target object store is a target cloud object store. In some embodiments, the plurality of object stores includes a plurality of cloud object stores. In some embodiments, the plurality of object stores is coupled to the enterprise object store. In some embodiments, the processor selects the target object store based on a configuration (e.g., the configuration 122).

At operation 506, the processor translates the first object request to a second object request. In some embodiments, the second object request is to execute the I/O on the object. In some embodiments, the processor translates the first object request to the second object request using a mapping (e.g., the mapping 124) that maps the first object request to the second object request. In some embodiments, the second object request is in accordance with a second protocol of the target object store. In some embodiments, the second object request is an application programming interface (API) call to an API unique to the target object store.

In some embodiments, the processor translates a first identifier of an object in the first object request to a second identifier in the second object request. In some embodiments, the first identifier is in accordance with the first protocol and the second identifier is in accordance with the second protocol. In some embodiments, the first identifier is a first version identifier and the second identifier is a second version identifier. In some embodiments, the processor translates a first version identifier and a first upload identifier of an object in the first object request to a second version identifier and second upload identifier in the second object request, respectively. In some embodiments, the first identifier is a first upload identifier and the second identifier is a second upload identifier. In some embodiments, the processor translates a first API of an object in the first object request to a second API in the second object request. In some embodiments, the first API is in accordance with the first protocol and the second API is in accordance with the second protocol. In some embodiments, the processor translates a first identifier and a first API of an object in the first object request to a second identifier and a second API in the second object request, respectively.

At operation 508, the processor sends the second object request to the target object store. In some embodiments, the target object store replicates an object stored in the enterprise object store in accordance with the second object request.

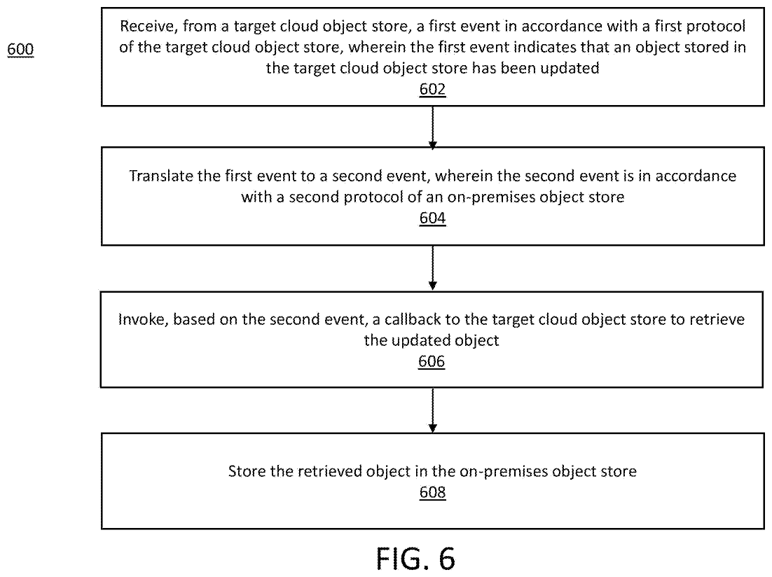

Referring now to FIG. 6, a flowchart of an example method 600 for receiving an event from a remote object store, in accordance with some embodiments of the present disclosure. The method 600 may be implemented using, or performed by one or more of the systems (e.g., the system 100, the system 300, the system 400, the network environment 700, the cloud computing environment 701, or the computing device 703), one or more components (e.g., the client system 102, virtual object store 110, the translation agent 116, the replication manager 308, etc.) of one or more of the systems, or a processor associated with one or more of the systems or one or more components. Additional, fewer, or different operations may be performed in the method 600 depending on the embodiment. Additionally, or alternatively, two or more of the operations of the method 600 may be performed in parallel. One or more of the operations or embodiments of the method 600 may be combined with, or performed before, after, or in parallel with one or more of the operations or embodiments of the method 500.

At operation 602, the processor (e.g., a processor of the virtual object store 110) receives, from a target object store (e.g., a remote object store such as the object store 128A), a first event (e.g., event 403) in accordance with a first protocol of the target object store. In some embodiments, the target object store is a target cloud object store. In some embodiments, the first event indicates that an object is stored in the target object store or that the stored object has been updated. In some embodiments, the object stored in accordance with the object request 401. In some embodiments, the processor subscribes to a message broker (e.g., the message broker 402) of the target object store and the processor receives the event based on being subscribed to the message broker.

At operation 604, the processor translates the first event to a second event (e.g., the event 114). In some embodiments, the second event is in accordance with a second protocol of an enterprise (e.g., on-premises) object store (e.g., the object store 108). In some embodiments, the processor translates a first identifier of an object associated with the first event to a second identifier in the second event. In some embodiments, the first identifier is in accordance with the first protocol and the second identifier is in accordance with the second protocol.

At operation 606, the processor invokes, based on the second event, a callback to the target object store to retrieve the updated object. At operation 608, the processor stores the retrieved object in the enterprise object store.

FIG. 7A depicts an example network environment that can be used in connection with the methods and systems described herein. In brief overview, the network environment 700 includes one or more clients devices 102 (also generally referred to as clients, client node, client machines, client computers, client computing devices, endpoints, or endpoint nodes) in communication with one or more servers 702 (also generally referred to as servers, nodes, or remote machine) via one or more networks 106. In some embodiments, a client system 102 has the capacity to function as both a client node seeking access to resources provided by a server and as a server providing access to hosted resources for other client systems 102.

Although FIG. 7A shows a network 106 between the client systems 102 and the servers 702, the client systems 102 and the servers 702 can be on the same network 106. In embodiments, there are multiple networks 106 between the client systems 102 and the servers 702. The network 106 can include multiple networks such as a private network and a public network. The network 106 can include multiple private networks.

The network 106 can include one or more component or functionality of network 106 depicted in FIG. 7A. The network 106 can be connected via wired or wireless links. Wired links can include Digital Subscriber Line (DSL), coaxial cable lines, optical fiber lines, shielded twisted pairs, or unshielded twisted pairs. The wired links can connect one or more Ethernet networks. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, 4G, 5G or other standards. The network standards can qualify as one or more generation of mobile telecommunication standards by fulfilling a specification or standards such as the specifications maintained by International Telecommunication Union. Examples of cellular network standards include AMPS, GSM, GPRS, UMTS, LTE, LTE Advanced, Mobile WiMAX, and WiMAX-Advanced. Cellular network standards can use various channel access methods e.g. FDMA, TDMA, CDMA, or SDMA. In some embodiments, different types of data can be transmitted via different links and standards. In other embodiments, the same types of data can be transmitted via different links and standards.

The network 106 can be any type and/or form of network. The geographical scope of the network 106 can vary widely and the network 106 can be a body area network (BAN), a personal area network (PAN), a local-area network (LAN), e.g. Intranet, a metropolitan area network (MAN), a wide area network (WAN), or the Internet. The topology of the network 106 can be of any form and can include, e.g., any of the following: point-to-point, bus, star, ring, mesh, or tree. The network 106 can be an overlay network that is virtual and sits on top of one or more layers of other networks 106. The network 106 can be of any such network topology as known to those ordinarily skilled in the art capable of supporting the operations described herein. The network 106 can utilize different techniques and layers or stacks of protocols, including, e.g., the Ethernet protocol or the internet protocol suite (TCP/IP). The TCP/IP internet protocol suite can include application layer, transport layer, internet layer (including, e.g., IPv6), or the link layer. The network 106 can be a type of a broadcast network, a telecommunications network, a data communication network, or a computer network.

The network environment 700 can include multiple, logically grouped servers 702. The logical group of servers can be referred to as a data center 708 (or server farm or machine farm). In embodiments, the servers 702 can be geographically dispersed. The data center 708 can be administered as a single entity or different entities. The data center 708 can include multiple data centers 708 that can be geographically dispersed. The servers 702 within each data center 708 can be homogeneous or heterogeneous (e.g., one or more of the servers 702 or machines 702 can operate according to one type of operating system platform (e.g., WINDOWS), while one or more of the other servers 702 can operate on according to another type of operating system platform (e.g., Unix, Linux, or Mac OS)). The servers 702 of each data center 708 do not need to be physically proximate to another server 702 in the same machine farm 708. Thus, the group of servers 702 logically grouped as a data center 708 can be interconnected using a network. Management of the data center 708 can be de-centralized. For example, one or more servers 702 can comprise components, subsystems and modules to support one or more management services for the data center 708.

Server 702 can be a file server, application server, web server, proxy server, appliance, network appliance, gateway, gateway server, virtualization server, deployment server, SSL VPN server, or firewall. In embodiments, the server 702 can be referred to as a remote machine or a node. Multiple nodes can be in the path between any two communicating servers.

FIG. 7B illustrates an example cloud computing environment. A cloud computing environment 701 can provide client system 102 with one or more resources provided by a network environment. The cloud computing environment 701 can include one or more client systems 102, in communication with the cloud 710 over one or more networks 106. Client systems 102 can include, e.g., thick clients, thin clients, and zero clients. A thick client can provide at least some functionality even when disconnected from the cloud 710 or servers 702. A thin client or a zero client can depend on the connection to the cloud 710 or server 702 to provide functionality. A zero client can depend on the cloud 710 or other networks 106 or servers 702 to retrieve operating system data for the client device. The cloud 710 can include back-end platforms, e.g., servers 702, storage, server farms or data centers.

The cloud 710 can be public, private, or hybrid. Public clouds can include public servers 702 that are maintained by third parties to the client systems 102 or the owners of the clients. The servers 702 can be located off-site in remote geographical locations as disclosed above or otherwise. Public clouds can be connected to the servers 702 over a public network. Private clouds can include private servers 702 that are physically maintained by client systems 102 or owners of clients. Private clouds can be connected to the servers 702 over a private network 106. Hybrid clouds can include both the private and public networks 106 and servers 702.

The cloud 710 can also include a cloud-based delivery, e.g. Software as a Service (SaaS) 712, Platform as a Service (PaaS) 714, and Infrastructure as a Service (IaaS) 716. IaaS can refer to a user renting the use of infrastructure resources that are needed during a specified time period. IaaS providers can offer storage, networking, servers or virtualization resources from large pools, allowing the users to quickly scale up by accessing more resources as needed. PaaS providers can offer functionality provided by IaaS, including, e.g., storage, networking, servers or virtualization, as well as additional resources such as, e.g., the operating system, middleware, or runtime resources. SaaS providers can offer the resources that PaaS provides, including storage, networking, servers, virtualization, operating system, middleware, or runtime resources. In some embodiments, SaaS providers can offer additional resources including, e.g., data and application resources.

Client systems 102 can access IaaS resources, SaaS resources, or PaaS resources. In embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

The client system 102 and server 702 can be deployed as and/or executed on any type and form of computing device, e.g. a computer, network device or appliance capable of communicating on any type and form of network and performing the operations described herein.

FIG. 7C depicts block diagrams of a computing device 703 useful for practicing an embodiment of the client system 102 or a server 702. As shown in FIG. 7C, each computing device 703 can include a central processing unit 718, and a main memory unit 720. As shown in FIG. 7C, a computing device 703 can include one or more of a storage device 736, an installation device 732, a network interface 734, an I/O controller 722, a display device 730, a keyboard 724 or a pointing device 726, e.g. a mouse. The storage device 736 can include, without limitation, a program, such as an operating system, software, or software associated with system 100.

The central processing unit 718 is any logic circuitry that responds to and processes instructions fetched from the main memory unit 720. The central processing unit 718 can be provided by a microprocessor unit. The computing device 703 can be based on any of these processors, or any other processor capable of operating as described herein. The central processing unit 718 can utilize instruction level parallelism, thread level parallelism, different levels of cache, and multi-core processors. A multi-core processor can include two or more processing units on a single computing component.

Main memory unit 720 can include one or more memory chips capable of storing data and allowing any storage location to be directly accessed by the microprocessor 718. Main memory unit 720 can be volatile and faster than storage 736 memory. Main memory units 720 can be Dynamic random access memory (DRAM) or any variants, including static random access memory (SRAM). The memory 720 or the storage 736 can be non-volatile; e.g., non-volatile read access memory (NVRAM). The memory 720 can be based on any type of memory chip, or any other available memory chips. In the example depicted in FIG. 7C, the processor 718 can communicate with memory 720 via a system bus 738.

A wide variety of I/O devices 728 can be present in the computing device 703. Input devices 728 can include keyboards, mice, trackpads, trackballs, touchpads, touch mice, multi-touch touchpads and touch mice, microphones, multi-array microphones, drawing tablets, cameras, or other sensors. Output devices 728 can include video displays, graphical displays, speakers, headphones, or printers.

I/O devices 728 can have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices can have larger surfaces, such as on a table-top or on a wall, and can interact with other electronic devices. Some I/O devices 728, display devices 730 or group of devices can be augmented reality devices. The I/O devices can be controlled by an I/O controller 722 as shown in FIG. 7C. The I/O controller 722 can control one or more I/O devices, such as, e.g., a keyboard 724 and a pointing device 726, e.g., a mouse or optical pen. Furthermore, an I/O device can also provide storage and/or an installation device 732 for the computing device 703. In embodiments, the computing device 703 can provide USB connections (not shown) to receive handheld USB storage devices. In embodiments, an I/O device 728 can be a bridge between the system bus 738 and an external communication bus, e.g. a USB bus, a SCSI bus, a FireWire bus, an Ethernet bus, a Gigabit Ethernet bus, a Fibre Channel bus, or a Thunderbolt bus.

In embodiments, display devices 730 can be connected to I/O controller 722. Display devices can include, e.g., liquid crystal displays (LCD), electronic papers (e-ink) displays, flexile displays, light emitting diode displays (LED), or other types of displays. In some embodiments, display devices 730 or the corresponding I/O controllers 722 can be controlled through or have hardware support for OPENGL or DIRECTX API or other graphics libraries. Any of the I/O devices 728 and/or the I/O controller 722 can include any type and/or form of suitable hardware, software, or combination of hardware and software to support, enable or provide for the connection and use of one or more display devices 730 by the computing device 703. For example, the computing device 703 can include any type and/or form of video adapter, video card, driver, and/or library to interface, communicate, connect or otherwise use the display devices 730. In embodiments, a video adapter can include multiple connectors to interface to multiple display devices 730.

The computing device 703 can include a storage device 736 (e.g., one or more hard disk drives or redundant arrays of independent disks) for storing an operating system or other related software, and for storing application software programs such as any program related to the systems, methods, components, modules, elements, or functions depicted in FIG. 1 or 2. Examples of storage device 736 include, e.g., hard disk drive (HDD); optical drive including CD drive, DVD drive, or BLU-RAY drive; solid-state drive (SSD); USB flash drive; or any other device suitable for storing data. Storage devices 736 can include multiple volatile and non-volatile memories, including, e.g., solid state hybrid drives that combine hard disks with solid state cache. Storage devices 736 can be non-volatile, mutable, or read-only. Storage devices 736 can be internal and connect to the computing device 703 via a bus 738. Storage device 736 can be external and connect to the computing device 703 via an I/O device 728 that provides an external bus. Storage device 736 can connect to the computing device 703 via the network interface 734 over a network 106. Some client devices 102 may not require a non-volatile storage device 736 and can be thin clients or zero client systems 102. Some storage devices 736 can be used as an installation device 732 and can be suitable for installing software and programs.

The computing device 703 can include a network interface 734 to interface to the network 106 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac/ax, CDMA, GSM, WiMAX, and direct asynchronous connections). The computing device 703 can communicate with other computing devices 703 via any type and/or form of gateway or tunneling protocol e.g., Secure Socket Layer (SSL) or Transport Layer Security (TLS), or QUIC protocol. The network interface 734 can include a built-in network adapter, network interface card, PCMCIA network card, EXPRESSCARD network card, card bus network adapter, wireless network adapter, USB network adapter, modem or any other device suitable for interfacing the computing device 703 to any type of network capable of communication and performing the operations described herein.

A computing device 703 of the sort depicted in FIG. 7C can operate under the control of an operating system, which controls scheduling of tasks and access to system resources. The computing device 703 can be running any operating system configured for any type of computing device, including, for example, a desktop operating system, a mobile device operating system, a tablet operating system, or a smartphone operating system.

The computing device 703 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computing device 703 has sufficient processor power and memory capacity to perform the operations described herein. In some embodiments, the computing device 703 can have different processors, operating systems, and input devices consistent with the device.

In embodiments, the status of one or more machines (e.g., client devices 102 and servers 702) in the network 106 can be monitored as part of network management. In embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein.

The processes, systems and methods described herein can be implemented by the computing device 703 in response to the CPU 718 executing an arrangement of instructions contained in main memory 720. Such instructions can be read into main memory 720 from another computer-readable medium, such as the storage device 736. Execution of the arrangement of instructions contained in main memory 720 causes the computing device 703 to perform the illustrative processes described herein. One or more processors in a multi-processing arrangement may also be employed to execute the instructions contained in main memory 720. Hard-wired circuitry can be used in place of or in combination with software instructions together with the systems and methods described herein. Systems and methods described herein are not limited to any specific combination of hardware circuitry and software.

Although an example computing system has been described in FIG. 7C, the subject matter including the operations described in this specification can be implemented in other types of digital electronic circuitry, or in computer software, firmware, or hardware, including the structures disclosed in this specification and their structural equivalents, or in combinations of one or more of them.

It is to be understood that any examples used herein are simply for purposes of explanation and are not intended to be limiting in any way.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the disclosure be defined by the claims appended hereto and their equivalents.

What is claimed:

1. An apparatus comprising a processor and a memory, wherein the memory comprises programmed instructions that, when executed by the processor, cause the apparatus to:
receive a first object request to execute an input/output (I/O) on an object stored in an on-premises object store, wherein the first object request is in accordance with a first protocol of the on-premises object store;
select a target cloud object store of a plurality of cloud object stores, wherein the plurality of object stores is coupled to the on-premises object store;
translate the first object request to a second object request to execute the I/O on the object, wherein the second object request is in accordance with a second protocol of the target cloud object store; and
send the second object request to the target cloud object store.

2. The apparatus of claim 1, wherein the I/O is to replicate the object.

3. The apparatus of claim 1, wherein the second object request is an application programming interface (API) call to an API unique to the target cloud object store.

4. The apparatus of claim 1, wherein the memory comprises the programmed instructions that, when executed by the processor, cause the apparatus to:
select the target cloud object store based on a configuration.

5. The apparatus of claim 1, wherein the memory comprises the programmed instructions that, when executed by the processor, further cause the apparatus to:
receive, from the target cloud object store, an event indicating that the object has been updated in the target cloud object store.

6. The apparatus of claim 5, wherein the memory comprises the programmed instructions that, when executed by the processor, cause the apparatus to:
invoke a callback to the target cloud object store to retrieve the updated object; and
store the updated object in the on-premises object store.

7. The apparatus of claim 5, wherein the memory comprises the programmed instructions that, when executed by the processor, cause the apparatus to:
subscribe to a message broker of the target cloud object store; and
receive the event based on being subscribed to the message broker.

8. The apparatus of claim 1, wherein the memory comprises the programmed instructions that, when executed by the processor, further cause the apparatus to:
translate a first identifier of an object in the first object request to a second identifier in the second object request, wherein the first identifier is in accordance with a first protocol and the second identifier is in accordance with a second protocol.

9. The apparatus of claim 8, wherein the first identifier is a first version identifier and the second identifier is a second version identifier.

10. The apparatus of claim 8, wherein the first identifier is a first upload identifier and the second identifier is a second upload identifier.

11. A non-transitory, computer-readable medium comprising instructions that, when executed by a processor, cause the processor to:
receive a first object request to execute an input/output (I/O) on an object stored in an on-premises object store, wherein the first object request is in accordance with a first protocol of the on-premises object store;
select a target cloud object store of a plurality of cloud object stores, wherein the plurality of object stores is coupled to the on-premises object store;
translate the first object request to a second object request to execute the I/O on the object, wherein the second object request is in accordance with a second protocol of the target cloud object store; and
send the second object request to the target cloud object store.

12. The medium of claim 11, wherein the I/O is to replicate the object.

13. The medium of claim 11, wherein the second object request is an application programming interface (API) call to an API unique to the target cloud object store.

14. The medium of claim 11, wherein the instructions further cause the processor to:
select the target cloud object store based on a configuration.

15. The medium of claim 11, wherein the instructions further cause the processor to:
receive, from the target cloud object store, an event indicating that the object has been updated in the target cloud object store.

16. The medium of claim 15, wherein the instructions further cause the processor to:
invoke a callback to the target cloud object store to retrieve the updated object; and
store the updated object in the on-premises object store.

17. The medium of claim 15, wherein the instructions further cause the processor to:
subscribe to a message broker of the target cloud object store; and
receive the event based on being subscribed to the message broker.

18. The medium of claim 11, wherein the instructions further cause the processor to:
translate a first identifier of an object in the first object request to a second identifier in the second object request, wherein the first identifier is in accordance with a first protocol and the second identifier is in accordance with a second protocol.

19. The medium of claim 18, wherein the first identifier is a first version identifier and the second identifier is a second version identifier.

20. The medium of claim 18, wherein the first identifier is a first upload identifier and the second identifier is a second upload identifier.
